(19) United States
(12) Patent Application Publication
(10) Pub. No.: US 2003/0013205 A1
(43) Pub. Date: Jan. 16, 2003

(54) Separating device

(76) Inventor: Franz Konrad, Schwanenstadt (AT)

Correspondence Address: COLLARD & ROE, P.C., 1077 Northern Boulevard, Roslyn, NY, 11576-1696, US

(21) Appl. No.: 09/900,525

(22) Filed: Jul. 6, 2001

(51) Int. Cl. B01L 3/00; G01N 1/18

(52) U.S. Cl. 436/177; 422/99; 422/100; 422/101; 436/178

(57) ABSTRACT

The invention relates to a separating device (2) for isolating at least one component from a sample of biological origin comprising a liquid-permeable separating element (6), in particular having pores, disposed in a vessel (3). In at least one of its end regions, the vessel (3) has one at least more or less gas-impermeable connecting element (29) for connecting the vessel (3) to another vessel (5) or to a connecting device (4) for another vessel (5), e.g. a blood-sampling tube.

### FIELD OF THE INVENTION

The invention relates to a separating device for isolating at least one component from a sample of biological origin, a kit incorporating the separating device, a method of separating at least one component from a sample of biological origin and the corresponding kit, as outlined in the generic parts of claims 1, 23 and 34, 41 and 42.

### PRIOR ART

Given the fact that analysis of genetic coding is coming to play an increasingly important role in modern diagnostic analysis, there have been numerous developments in this area in recent times. One of the most common approaches today is to extract nucleic acids, in other words RNA or DNA, from whole blood and blood fractions. The inherent advantage of these methods is the fact that blood offers a much higher yield of nucleic acids than other bodily secretions. It is now common practice to stabilise the extracted blood with anti-coagulants, e.g. EDTA. The resultant sample material is then subjected to a treatment at low temperature in order to keep premature degradation of RNA caused by RNAses at least to a negligible level, after which these samples are transported to a laboratory for analysis. The analysis itself, for example PCR and RT-PCT as known from the prior art for example, starts as a rule with a series of preparatory steps, the purpose of which is to concentrate the nucleic acids. Amongst other things, these preparatory steps also involve treating the test substance with various buffers, in order to destroy the solvate coating which normally surrounds the nucleic acid, thereby enabling it to be concentrated or separated. The separation process itself may take place in separating columns, whereby the nucleic acids are adsorbed on the separation medium, e.g. a silicate membrane, due to their surface charge, which enables them to be separated from the “filtrate”. After various washing steps, the solvate coating of the nucleic acids is regenerated using a special buffer solution so that they are desorbed and can be removed with the eluate. Centrifuges are usually used for this process of separating or concentrating the nucleic acids.

The disadvantage of this approach is that the samples have to be manually handled between the individual steps, for example with various pipettes, and there is always a risk of the samples becoming contaminated.

As a result, numerous attempts have been made to simplify this process. WO 00/09746 A1, for example, proposes a vessel for taking blood samples, which contains an aqueous solution of a guanidinium salt, a buffer substance, a reducing agent and/or a detergent. The advantage of this type of blood sampling tube resides in the fact that the nucleic acids are stabilised and undergo lysis due to the presence of the reagent mixture as the blood is extracted.

### OBJECT AND ADVANTAGES OF THE INVENTION

The objective of the invention is to propose a means by which the approach to separating and concentrating a component from a blood sample can be simplified. Another part-objective of the invention is to provide a more reliable system in terms of both potential contamination and working safety.

This objective of the invention is achieved independently by means of the separating device and the kit as well as by the method used to separate at least one component from a sample of biological origin as defined by the features in the characterising parts of claims 1, 23 and 34. The advantages of this system reside in the fact that the separating element is disposed in a vessel which has a connecting element to connect this vessel to another vessel or to a connecting device for a vessel and the kit incorporating this separating device constitutes a system which can be handed to the user and which, from the work point of view, has been so prepared that at least one component can be immediately separated without having to insert individual vessels one inside the other beforehand, as has been common practice to date, i.e. in particular a separating column which has to be placed in a centrifuge tube. Because this vessel has a connecting device for another vessel, contamination of these samples such as might occur with the conventional method of using pipettes, particularly in the case of blood samples, can at least be almost totally ruled out. The work involved in preparing samples prior to the actual analysis, i.e. separation of at least one component, will now be reduced simply to coupling a blood extraction tube with the separating device of the invention, which will make for a considerable saving in time, particularly in big laboratories working on a large scale, and will increase throughput rates, a factor of particular advantage given the increasing amount of testing conducted in the field of gene technology. Another advantage is the fact that if the capacity of the vessel is dimensioned accordingly, other steps involved in preparing the sample can also be effected in this vessel, i.e. preparations required prior to analysing the component such as washing steps for example, in which case the washing solutions or washing buffers can be supplied by the manufacturers of these solutions in different containers, which may optionally be adapted to the appropriate quantity, so that the preparatory steps can be performed in a closed system without risk of contamination. The use of pipettes, which has been commonplace in the past, can now be dispensed with, at least for the most part.

Other advantageous embodiments of the separating device are defined in claims 2 to 19.

Claim 2 defines an advantageous system in which the vessel has another connecting element in the second end region lying opposite the first end region so that the vessel can be accessed from both ends, which enables a filtrate to be drained and the capacity of the container reduced accordingly. This also means that the individual washing filtrates can be drawn off separately. As a result of this second connecting element, it is also possible to connect other items of equipment to the vessel, e.g. a pressure pump, a vacuum pump.

In claim 3, the connecting element is designed as a piercable, self-closing septum which can be used in conjunction with a proven closure and connection fitting for the vessel in which the extracted blood is stored, so that tubes of this type used for drawing blood samples can be readily connected to the separating device and used, together with its fittings, in known proven technological processing. It is of advantage if the septum is retained in a screw cap as defined in claim 4, because this not only increases safety in terms of the vessel inadvertently working open during transportation for example, it also makes opening easier, should it prove necessary, since the screw cap merely has to be removed.

Another option is to fit the connecting element with a shut-off element, e.g. a tap, as defined in claim 5, so that the flow connection between the vessels can be interrupted, enabling a predetermined volume to be drawn off from the first vessel and transferred into the separating device, which is of particular advantage when it comes to taking reference specimens of the original sample.

Another advantage is the fact that the connecting element can be provided with a device for penetrating a septum because this enables a connection to be made very quickly and also allows evacuated vessels to be used.

Providing a fixing element as defined in claim 7 offers an advantage in that it offers a simple and effective option for providing a connection to the other vessel if the septum alone does not provide sufficient hold and guidance.

The separating element may also be designed as described in claim 8, which to a certain extent enables co-operation with known systems which have been tried and tested.

It is also advantageous if the separating element is arranged in a receptacle that can be placed in the vessel or if the receptacle has a lip in the region of one of its openings extending at least partially across the circumference of the receptacle and if the external diameter of the lip corresponds more or less approximately to a maximum external diameter of the receptacle and if the separating element is removably arranged in the vessel, as defined in claims 9 to 12, because this system offers an option whereby the separating element can be placed in the vessel in such a way that it can be easily removed and, if necessary, placed in another vessel, e.g. in order to elute the sample of component collected or concentrated on the separating element into another vessel.

This being the case, it is of advantage if the vessel has an annular groove on its internal face for securing the separating element or receptacle or if the vessel has at least a partial, in particular annular, lip on its internal face for retaining the separating device or the receptacle, as defined in claims 13 or 14, or if the container has a cross-section widening as defined in claim 15, since this will enable the separating element to be retained at a predeterminable height in the vessel.

The receptacle may also be secured in a cap as outlined in claim 16, in which case the vessel can be opened and the receptacle removed in a single work step.

By providing a stationary phase for at least one other component as outlined in claim 17, more than one component can be separated from the biological sample in a single work step.

It is of advantage if the vessel as defined in claim 18 is evacuated or can be evacuated or if the vacuum defined in claim 19 can be adjusted so that a predetermined quantity of the sample can be sucked into the vessel, because firstly this provides a simple way of providing specimens of the original sample and secondly the centrifuging step can be dispensed with. The advantage of being able to produce a vacuum primarily resides in the fact that once the sample or a specific quantity of the sample has been added, the vessel can be evacuated again in order to perform other work steps, e.g. washing steps, in a similar manner. It may be of advantage if the washing solution or buffer solution is applied to the separating element or receptacle beforehand and the vessel is not evacuated until after a shorter or longer period has elapsed to allow the desired action.

Advantageously, the vessel may be designed in the form of a blood sampling tube as defined in claim 20 because this will obviate the need for special and expensive injection moulds to make the separating device.

Finally, it is of advantage if the receptacle has an extraction device as defined in claims 21 and 22, which will make it possible to remove the separating element with the aid of tools, such as tweezers, from the vessel containing the separating device, thereby avoiding contamination of the separated component as might occur if the fingers of the user of the separating system were to come into direct contact with the separating element.

Various embodiments of the kit proposed by the invention are defined in claims 24 to 33.

With this system, it is of advantage if the connecting device defined in claim 24 and 25 has at least one device for penetrating a septum and if the penetrating device is a cannula, which will enable a flow connection to be set up quickly and easily between two vessels.

The design of the connecting device in the form of a vessel as defined in claim 26 has advantages, especially if the vessel walls project beyond the cannula along a longitudinal central axis of the connecting device, at least on one side of the connecting device, which will not only secure a better hold and guiding action for the vessel as the flow connection is being established, it will also help to protect the user from injury, e.g. by the cannula.

Similar advantages are obtained using the embodiments defined in claims 27 and 28, i.e. if the cannula is retained at an end region of a vessel and if at least one cannula end is additionally protected by a protective device.

If the closure element is arranged in the connecting device as defined in claim 29, it is possible to predetermine the point at which the flow connection between the vessels can be interrupted, e.g. to perform individual washing steps, in which case the washing solution or buffer solution can be drawn off from a larger container used for all washing steps.

Other advantages may be obtained if the connecting device is provided with a fixing element in one of its end regions, as defined in claim 30, which will retain and guide the vessel in the connecting device accordingly.

Another option is to design the other vessel defined in claim 31 as a blood sampling tube, obviating the need to transfer the biological sample, in particular the blood, from a vessel specifically used for taking the sample.

It is of particular advantage if the other vessel contains a reagent or a reagent mixture for stabilising and lysing whole blood and if the reagent or reagent mixture is a guanidinium salt, as defined in claim 32 or 33, which will firstly shorten the time and effort needed to specify a component of a biological sample and secondly obviate the need for costly cold storage systems and transportation from the doctor taking the blood sample to the laboratory.

Finally, advantageous embodiments of the method proposed by the invention are set out in claims 35 to 40.

There is an advantage to be had if the second vessel is designed as a separating device of the type proposed by the invention and defined in claim 35, which will shorten and simplify the method accordingly.

In order to separate the component from the sample, the separating element can be removed from the second vessel or the separating element can be transferred to another vessel for processing or preparatory steps in readiness for analysis, as defined in claims 36 and 37, because the filtrate and the component can be processed separately, if necessary.

The component can also be washed in the second vessel, as defined in claim 38, which dispenses with separate intermediate steps, in particular having to place the separating element in another vessel.

This being the case, it is of advantage if this second vessel is evacuated prior to a washing step as defined in claim 39 or 40 and if the buffer solution is conveyed at above atmospheric pressure so that the time-consuming centrifuging steps can be dispensed with.

The use of the separating device or kit for analysing nucleic acid is described in claims 41 and 42.

### BRIEF DESCRIPTION OF THE DRAWINGS

To provide a clearer understanding, the invention will be described in more detail below with reference to the appended drawings. Of these:

FIG. 1 illustrates a kit for separating at least one component from a sample of biological origin using a separating system as proposed by the invention;

FIG. 2 shows another embodiment of the separating system;

FIG. 3 illustrates another embodiment of the separating system;

FIG. 4 is an embodiment of the separating system in which the vessel in which the separating device is disposed has two access openings to the interior of the vessel;

FIG. 5 shows an embodiment of the connecting device, seen in section from a side view;

FIG. 6 shows an embodiment of the connecting device, seen in section from a side view;

FIG. 7 shows an embodiment of the connecting device, seen in section from a side view;

FIG. 8 is a plan view of the connecting device illustrated in FIG. 7;

FIG. 9 shows an embodiment of the connecting device, seen in section from a side view;

FIG. 10 shows an embodiment of the connecting device, seen in section from a side view;

FIG. 11 shows an embodiment of the separating device, seen in section from a side view;

FIG. 12 shows an embodiment of the separating device, seen in section from a side view;

FIG. 13 shows an embodiment of the connecting device, seen in section from a side view;

FIG. 14 shows an embodiment designed to retain the separating element in the separating device, seen in section from a side view;

FIG. 15 shows another embodiment designed to retain the separating element in the separating device, seen in section from a side view;

FIG. 16 shows another embodiment designed to retain the separating element in the separating device, seen in section from a side view;

FIG. 17 shows embodiments of the separating element with safety features for removing same from the separating device, seen in section from a side view.

### DETAILED DESCRIPTION

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may also be construed as independent inventive solutions or solutions proposed by the invention in their own right.

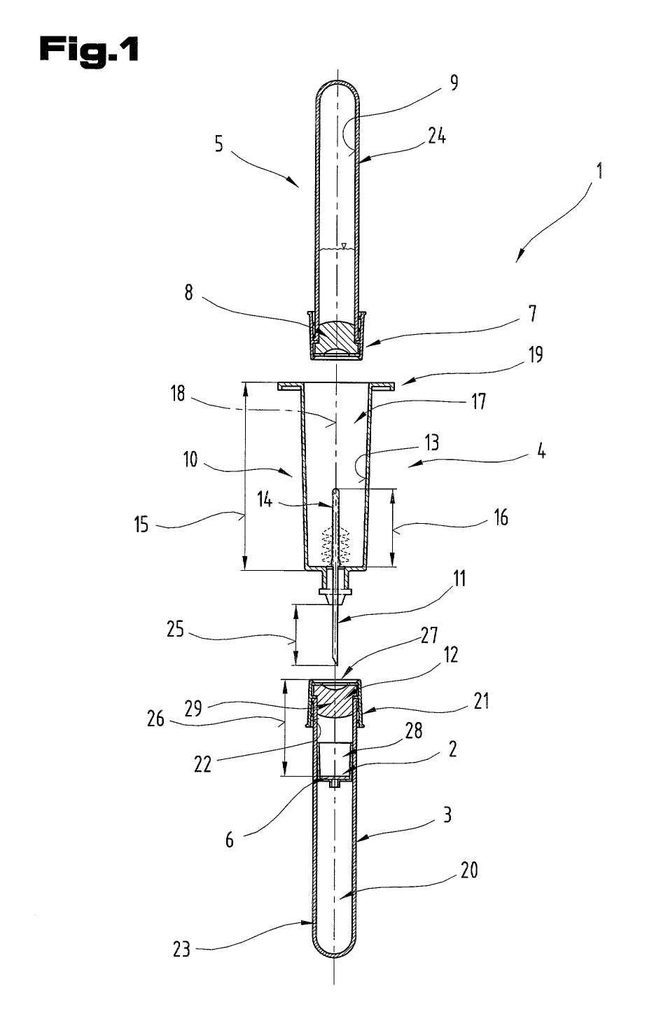

FIG. 1 illustrates a first embodiment of a kit 1 as proposed by the invention, for separating at least one component from a sample of biological origin. This kit 1 comprises a separating device 2, designed in the form of a vessel 3, by means of which at least one component can be isolated from the rest of the sample, a connecting device 4 and another vessel 5, which, in the embodiment illustrated as an example here, is a tube for drawing a blood sample.

Preferably, the kit 1, in particular the separating device 2, may be used to produce a concentration of nucleic acids, in other words DNA or RNA for example, from whole blood.

Clearly, the separating device 2 and the kit 1 may also be used to produce a concentration of other components contained in blood or can be used to isolate several components from blood simultaneously and a separating element 6 disposed in the separating device 2 for this purpose may be designed accordingly. In what follows, however, only the process of obtaining concentrated nucleic acids will be discussed and the design of the separating device is therefore adapted to this application, although this should not be construed as restrictive in any respect.

The sample to be analysed, i.e. whole blood in the example described here, is taken in a conventional manner, known from the prior art, using the vessel 5. This vessel 5 has a closure cap 7 at its open end, in which a piercable, self-closing septum 8 is inserted. Designs of blood-sampling tubes or vessels 5 of this type are known, e.g. from WO 95/17253 A1, and the contents of this document are incorporated in this description as part of the subject-matter, although it should be said that single-layer vessels 5 may also be used.

Naturally, all known types of blood-sampling tubes as well as vessels 5 of a different design may be used in the proposed analysis kit, in which case the respective vessel 5 may constitute a part of the kit 1 proposed by the invention or may be separate from the kit 1, in other words may be regarded as an optional feature of the kit 1 proposed by the invention, the advantage being that the nature of this vessel 5 is not restricted just to those provided by the manufacturer of the system.

By preference, an evacuated blood-sampling tube is used as the vessel 5 for with-drawing the blood, already containing a reagent or reagent mixture for stabilising and/or lysing the blood, i.e. the cells, thereby preventing any premature break-down of nucleic acids by RNAases. This reagent or reagent mixture may be a guanidinium salt, as mentioned above, and disclosed in WO 00/09746 A1, which also forms part of the content of this description, plus a buffer substance, a reducing agent and/or a detergent as specified in WO 00/09746 A1 and in the ranges of concentration specified therein. By using this reagent composition, the blood sample can be stabilised in such a way that for a certain period of time, e.g. 3 to 5 days, there is no need to place it in cold storage as is currently common practice. Furthermore, this reagent mixture already takes care of one of the steps required to prepare the sample, namely lysis, so that the nucleic acids are released from the cells.

Various agents may also be placed in the vessel 5, e.g. sprayed onto a vessel internal wall 9.

It may also be that the septum 8 is not disposed in a closure cap 7, e.g. a screw cap, and retained thereby in the vessel but is instead retained solely by a friction fit between the vessel internal wall 9 and the septum 8, particularly if the septum 8 is made from a rubber, e.g. bromobutyl rubber. Alternatively, the friction fit may be provided in the form of a screw cap with a septum retained therein, particularly if the vessel 5 is an evacuated blood-sampling tube.

The connecting device in the embodiment illustrated as an example in FIG. 1 is provided in the form of a vessel 10 with a double-ended cannula 11 retained in its bottom end region. This cannula 11 penetrates firstly the septum 8 of the vessel 5 and secondly another septum 12 of the separating device 2, thereby establishing the flow connection between the vessel 5 and the separating device 2, i.e. the vessel 3.

The advantage of designing the connecting device 4 as a vessel is that the vessel 5 is in effect guided and retained against a vessel internal wall 13 of the vessel 10 when the vessel 5 is inserted or nested in the connecting device 4.

However, the connecting device 4 may also be designed so that it essentially encloses only the cannula 11. It may optionally be provided with a handling piece. This very simple embodiment may be used in particular if the vessel 5 can be adequately held and/or guided by the cannula alone.

As illustrated in FIG. 1, the cannula 11 may have a safety feature 14 on at least one of its end regions. This safety feature 14 may be provided in the form of a hose valve, for example, which, as illustrated by broken lines in FIG. 1, can be pushed back as the vessel 5 is pushed on so that the cannula is released due the fact that a resistance exerted by this hose valve when the vessel 5 is pushed on is too low to penetrate the septum 8 of the vessel 5.

A flow connection is therefore established between the cannula 11 and the vessel 5.

As may be seen from FIG. 1, the vessel may be of a vessel height 15 which is greater than a height 16 of the part of the cannula 11 projecting into a vessel interior 17 of the vessel 10. This specifically improves the safety of the system, largely avoiding any risk of the user sustaining injury from the tip of the cannula 11.

At an end region of the vessel 10 lying opposite the end region in which the cannula 11 is retained, in the direction of a longitudinal central axis 18, the vessel 10 is open and may have a vessel lip 19, in particular encircling the entire circumference. This improves the ease with which the system can be handled and in particular the connecting device 4 when the vessel is pushed in.

The other cannula part of the double-ended cannula 11 projecting out from the connecting device 4 may also have a safety feature 14 (not illustrated), e.g. a screw cap, which is removed before using the connecting device 4 in order to free this cannula end.

In order to establish a flow connection between vessel 5 and the vessel 3, i.e. the separating device 2, this open cannula end is inserted through the septum into a separating device interior 20, penetrating the septum 12 in a known manner.

This septum 12 may be of a design similar to that of the septum 8 of the vessel 5 and may be made from bromobutyl rubber, for example, again being retained in a closure cap 21, e.g. a screw cap.

As may be seen from FIG. 1, at least a partial space is formed between a closure cap interior wall 22 and the septum 12 or 8 so that a vessel bottom part 23 or 24 can be pushed in or screwed in, enabling the screw cap to be secured to these vessel bottom parts 23, 24.

A length 25 of the part of the cannula 11 projecting beyond the connecting device 4 is such that the connecting device 4 does not pierce the separating element 6 disposed in the vessel 3 as it is pushed onto the vessel 3. Clearly, this could also be prevented by dimensioning the spacing 26 of the separating element 6 from the closure cap end face 27 lying opposite along the longitudinal central axis 18 accordingly. For example, if the vessel 3 is of a conical design becoming wider towards the top, i.e. in the direction towards the closure cap 21, a maximum diameter of the separating element 6 could be so selected that the latter is retained in the vessel 3 at a predeterminable height, e.g. by a friction fit.

In the example illustrated in FIG. 1, the separating element 6 is disposed in a receptacle 28 which can be placed inside the vessel 3. This receptacle 28 is designed to have two opposing openings lying along the longitudinal central axis 18, between which the separating element 6 is disposed. As a result, the sample can be applied to the separating element 6, the desired component separated from the sample and the filtrate to be drawn off from the sample drained.

The separating element 6 may be selected from a group consisting of filters, silicate membranes, ion-exchanger membranes and columns or separating columns. In particular, silicate membranes have been found to be particularly practical means for separating nucleic acids since they have a corresponding surface charge due to the shift in charge inside the “molecule” and thereby enable the charged nucleic acid molecules released to be adsorbed on the separating element 6.

It has been found to be of advantage if not only the vessel 5 but also the vessel 3, i.e. the separating device 2, is or can be evacuated since this will cause the sample to be automatically sucked through the cannula 11 into the vessel 3 when the flow connection is established between the vessels 3, 5. The vacuum, i.e. the under-pressure in the vessel 3, may be such that a specific quantity of fluid, e.g. in the range of between 0.2 ml and 1 ml, of sample is drawn off from the vessel 5, i.e. the blood-sampling tube. This is an easy way of providing samples for reference analysis, using the remainder of the sample left in the vessel 5, i.e. for repeating the analysis or for conducting different types of analysis. Using an evacuated vessel 3 also has the advantage of obviating the need for the centrifuging steps commonly applied when conducting this type of analysis in the current state of the art, which can be very time-consuming under certain circumstances.

In addition to the embodiments described above, the piercable, self-closing septum 12 may also be used as a connecting element 29 to connect the vessel 3 to the other vessel 5 with the aid of the connecting device 4. However, as explained below, the connecting element 29 may also be designed so that the cannula 11, for example, forms a part of the vessel 3 and the closure cap 21, enabling a direct flow connection to be set up with the vessel 5 without a connecting device 4.

In the embodiment illustrated in FIG. 1, the individual elements of the kit 1 are rounded in cross section, as is common practice with the tubes used for taking blood samples. However, this shape of cross section is not vital to the invention and other vessel cross sections would also be possible, e.g. rectangular, square, polygonal or similar.

It should also be pointed out at this stage that the design or fitting by which a cannula 11 is used in conjunction with the connecting device 4 or on the vessel 3, i.e. the separating device 2, is only one possible option and other connecting devices may be used to establish the flow connection between the vessels 3, 5.

Particularly if using evacuated or evacuable vessels 3, 5, it has been found to be of advantage if the connecting device is such that it enables an at least almost gas-impermeable connection between these two vessels. To this end, the cannula 11 may be made from the usual materials known from the prior art, for example metals. The vessels 3, 5 themselves may also be made of a corresponding material, e.g. glass, preferably plastics, in which case the design of the plastics can be used as a means of providing multi-layered vessels in which one layer provides a seal against the gas and another layer provides a seal against the liquid.

The examples described below are intended to illustrate different embodiments of the respective component parts of the kit I and all of the elements, in particular the connecting device 4 and the separating device 2 and, optionally the vessel 5, may be used in any combination with one another.

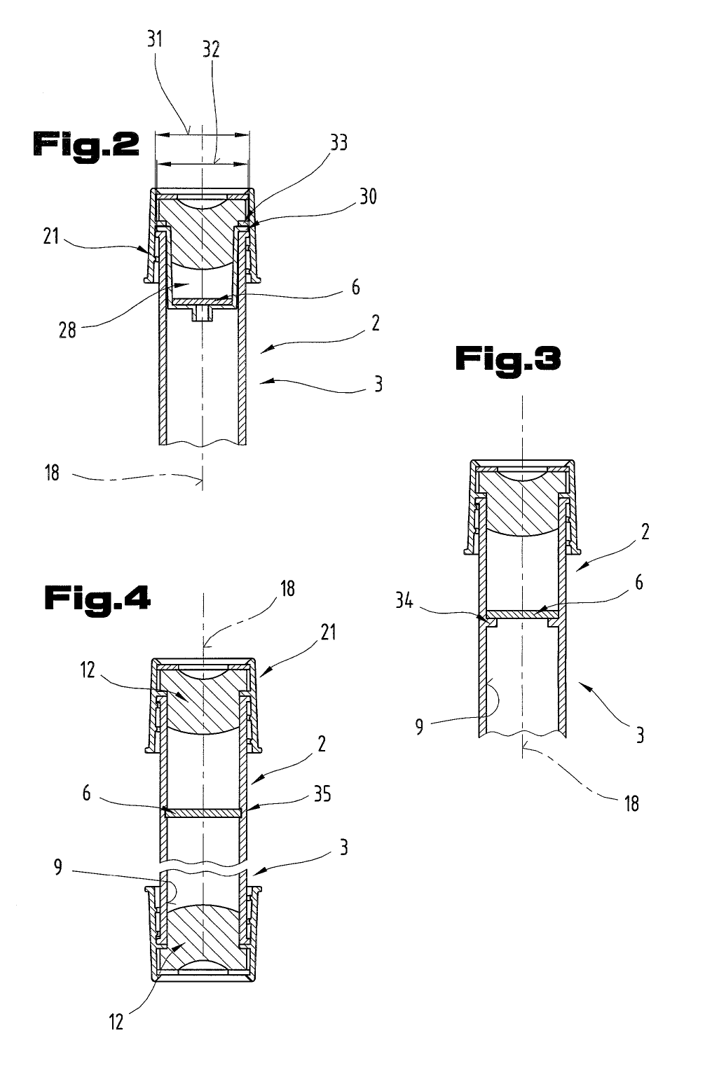

The embodiment illustrated in FIG. 2 shows a separating device 2, in which, in one of its openings, i.e. in particular the opening through which the sample flows into the receptacle 28, the receptacle 28 has a lip 39. By preference, an external diameter 31 of the lip 30, i.e. the maximum diameter, is such that the latter corresponds to an external diameter 32 of the receptacle 28 in this region, as a result of which, when the receptacle 28 is placed in the vessel 3, it lies against the wall thereof in the region of the opening of the vessel 3 and is clamped between the closure cap 21, in particular a lip 33 directed in a direction almost perpendicular to the longitudinal central axis 18, and the vessel 3 once the closure cap 21 has been pushed onto the vessel 3. This not only has the advantage of securing the receptacle 28 and the separating element 6 arranged therein firmly and reliably in the vessel 3, it also enables the receptacle 28 to be easily taken out of the vessel 3 when the closure cap 21 is removed, so that the component isolated on the separating element 6 can be further processed.

With this embodiment, it would naturally also be possible for the height of the receptacle 28 in the direction of the longitudinal central axis to be adapted to suit the cannula end, not illustrated, in particular the length 25 of the cannula 11.

FIG. 3 illustrates an embodiment of the separating device 2 in which the separating element 6 is not retained in a receptacle 28 but sits on a lip 34 projecting out from the vessel interior wall 9 towards the longitudinal central axis 18, at least in certain regions. It is an advantage to design this lip 34 so that it extends around the entire inner circumference, i.e. in the region of the interior of the vessel 3. The separating element 6 will then be of a plate-type design and its maximum diameter will fit within the internal diameter of the vessel 3, reducing the risk of any sample fluid introduced running around the separating element 6, between the latter and the vessel interior wall 9. Optionally, at least one seal may be provided between the vessel interior wall 9 and/or the lip 34 and the separating element 6, e.g. an O-ring or similar.

FIG. 4 illustrates what in effect are two embodiments of the separating device 2, although each of them may be used separately.

Firstly, a groove 35 is provided on the vessel interior wall 9 of the vessel 3.

Again the maximum diameter of the separating element 6 in the direction perpendicular to the longitudinal central axis 18 is such that the outer circumference of this separating element 6 engages in this groove 35, where it is prevented from moving, rather than being retained in a separate receptacle 28.

Secondly, the embodiment illustrated in FIG. 4 has a vessel 3 which can be closed at both end regions by the closure cap 21 so that the interior of the vessel 3 is accessible from both ends. The advantage of this embodiment is that the sample to be analysed can be introduced onto the separating element 6 via the septum 12 from one end region and the filtrate drained off from the separating element 6 can be discharged from the interior of the vessel 3 via the second end region, in particular another septum 12, with the aid of a cannula for example. Accordingly, the separating device 2 can be evacuated via the second end region again, e.g. after the sample has been introduced and the filtrate drained, so that other processing steps, such as washing steps, can be performed on the substance to be tested in one and the same vessel 3, i.e. separating device 2, in which case the washing fluid, in particular the washing buffer, can be introduced into the separating device 6 via the septum 12, i.e. a cannula inserted therethrough, and automatically sucked through the separating element 6, which obviates the need for various centrifuging steps.

With this embodiment, it is also possible to elute the component to be tested from the separating device 2 after preparation into another vessel, in which case the elution process can be operated from either end of the separating device. It is an advantage, if the closure cap 21 is removed and a cap with a shaped contour is used, such as that illustrated with the receptacle 28 of FIG. 2, since the test component can be selectively transferred into another vessel without wetting a very large part of the surface.

Also with this embodiment of the separating device, the individual liquids needed for preparing the sample can be conveyed above atmospheric pressure, particularly if the separating device 2 is connected by one of its end regions to a pressure pump, in which case the connection can again be made using a more or less cannula-type connecting piece.

Clearly, with the embodiment illustrated in FIG. 4, as with all the other embodiments of the separating device 2, the separating element 6 is removably disposed in the separating device 2, a suitably flexible material being used to make this separating element 6, for example, which springs into the groove 35 on insertion and conversely can be removed therefrom again.

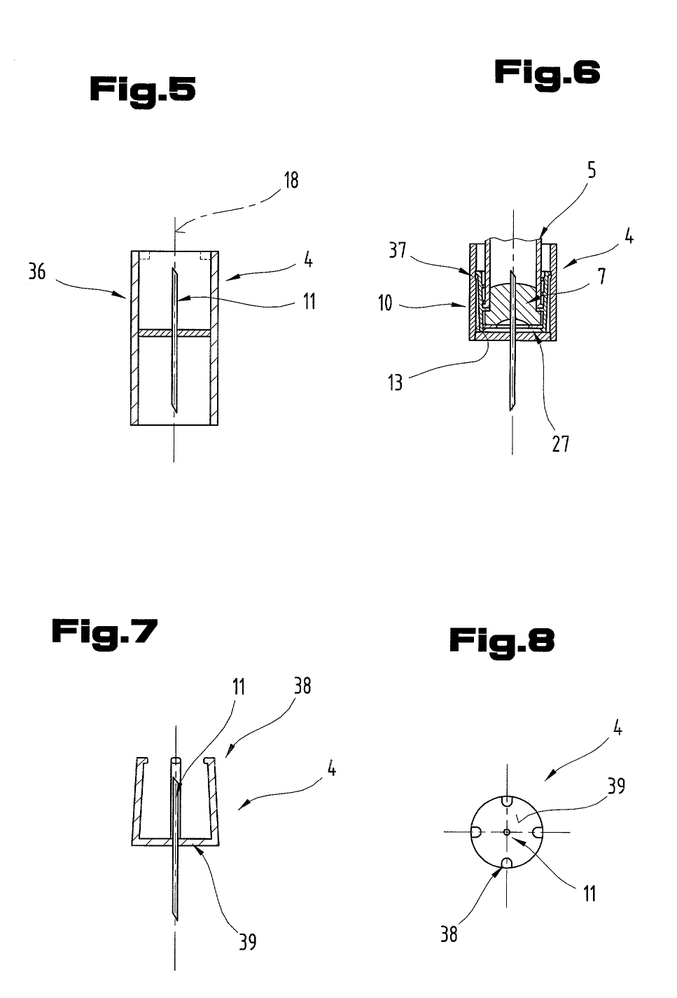

FIG. 5 depicts an embodiment of the connecting device 4. It has an at least approximately tubular-shaped external casing 36, open at both ends, in the interior of which the cannula 11, in particular double-ended, is secured along the longitudinal central axis 18, the fixing arrangement being such that the interior is divided into two separate part-chambers connected only via the cannula 11. The measurement of the two part-chambers along the longitudinal central axis 18 is longer than the length of the respective part of the cannula 11 projecting into this interior part. Accordingly, not only is the user better protected against the risk of injury, the vessels 3, 5, which are not illustrated in FIG. 5, can be more efficiently retained and guided at the same time.

FIG. 6 illustrates an embodiment of the connecting device 4 which is more or less the same as the connecting device 4 illustrated in FIG. 1 and again is provided in the form of a vessel 10. In this case, an annular groove 37 is provided in the vessel interior wall 13 so that the other vessel 5, i.e. the blood-sampling tube, can be retained in this groove 37 by an annular lip. This annular lip may be provided in the form of a closure cap 7, for example, in particular the region of the closure cap end face 27. This provides a fixing element or snap-fit closure to securely retain the vessel.

FIGS. 7 and 8 illustrate an embodiment of the connecting device with a different type of fixing element. The connecting device 4 of this embodiment is not tubular and instead, as illustrated more clearly in FIG. 8, has a base plate 39 with finger-like projections 38, which assume the role of fixing the vessel, not illustrated. At their ends lying opposite the base plate 39, these projections 38 have a widening in their cross section, by means of which the vessel 5 can be guided.

It is an advantage if, as illustrated in FIG. 7, these projections are of a conical design tapering in the end region opposite that of the base plate 39, these projections 38 having a certain degree of flexibility so that vessels 5 of different diameters may be inserted and fixed in the connecting device 4.

Clearly, any number of these projections 38 may be provided on this embodiment of the connecting device 4, the number of projections 38 not being limited to the four illustrated in FIG. 8.

Also with this embodiment, the length of the projections 38 may be such that the part of the cannula 11 pointing in the same direction is covered in this direction.

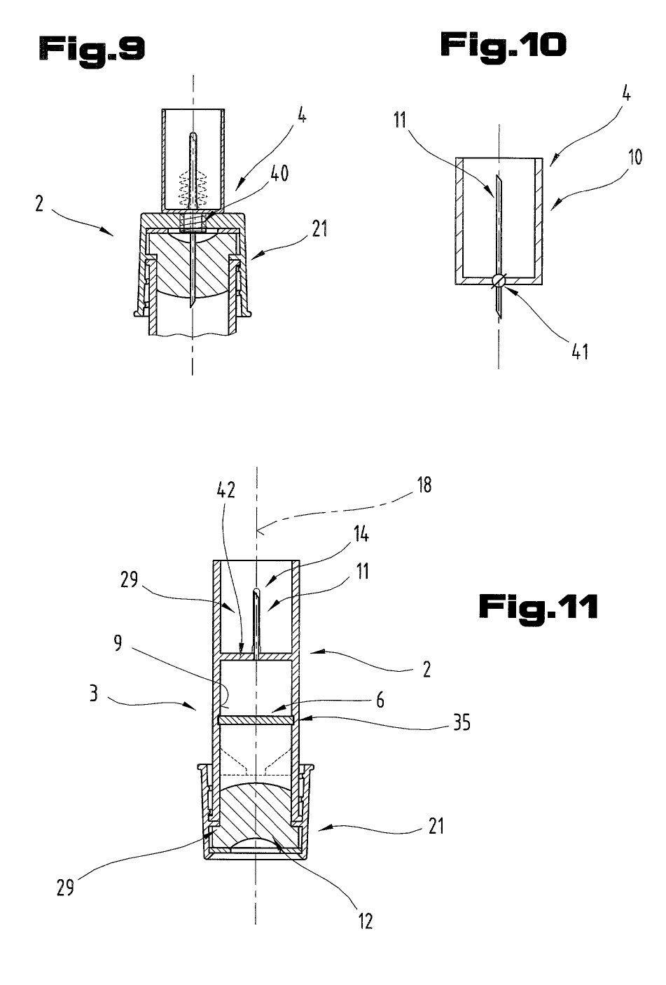

FIG. 9 illustrates an embodiment of the connecting device 4 which is again similar to the connecting device 4 illustrated in FIG. 1. The only difference is that the connecting device 4 of FIG. 9 has a thread 40 on its bottom face co-operating with the separating device 2. At the corresponding point in the closure cap 21, the separating device 2 has a matching counterthread so that the connecting device 4 can be screwed into the closure cap 21.

The advantage of this is that a secure connection can be produced between the separating device 2 and the connecting device 4, which will prevent these components of the analysis kit from inadvertently coming apart during handling under normal conditions.

FIG. 10 illustrates an embodiment of the connecting device 4 which is again provided in the form of a vessel 10, in which, in addition to the cannula 11, a tap for example can be connected by means of a closure element 41 which will allow the flow connection between the vessels 3, 5, not illustrated, to be interrupted. This closure element 41 may be disposed on a level with the floor of the vessel or in any other position.

FIG. 11 illustrates an embodiment of the separating device 2. As already described with reference to FIG. 4, it has the closure cap 21 on its bottom end so that the interior of the separating device 2, i.e. the vessel 3, is accessible from both ends. As with the embodiment illustrated in FIG. 4, the separating element 6 is retained in the interior by means of a groove 35 provided in the vessel interior wall 9.

In the embodiment illustrated in FIG. 11, the second top end region of the separating device 2 is provided with the connecting element 29. The connecting element 29 in this embodiment is provided as a cannula 11 which is retained or secured in a dividing wall 42 extending perpendicular to the longitudinal central axis 18 and closing off the interior of the separating device 2. The cannula 11 of this embodiment also projects from the wall of the separating device 2 in the direction of the longitudinal central axis 18 and may additionally have a safety feature 14, as illustrated.

The advantage of this embodiment is that the additional connecting device 4 can be dispensed with, due to the fact that the cannula 11 is arranged directly on the separating device 2, i.e. the connecting region is provided in the form of a cannula 11, so that the other vessel 5, not illustrated in FIG. 11, can be pushed directly onto the separating device 2.

The advantages of having access to the interior of the separating device 2 from both ends were described above.

With this embodiment, the separating device 2 does not have to be evacuated or evacuable, particularly since, as is the case with the embodiment illustrated in FIG. 4, a flow connection can be established via the second bottom connecting element 29, i.e. the septum 12, to a vacuum pump for example, or between another vessel, not illustrated, and the interior of the separating device 2 enabling the filtrate flowing off from the separating element 6 to drain into this other vessel which is placed under vacuum. The interior of the separating device 2 can be adapted, e.g. using a cone design underneath the separating element 6, so that a cannula of another vessel or a connecting device to an upstream vessel can be arranged so as to engage in the opening of the cone.

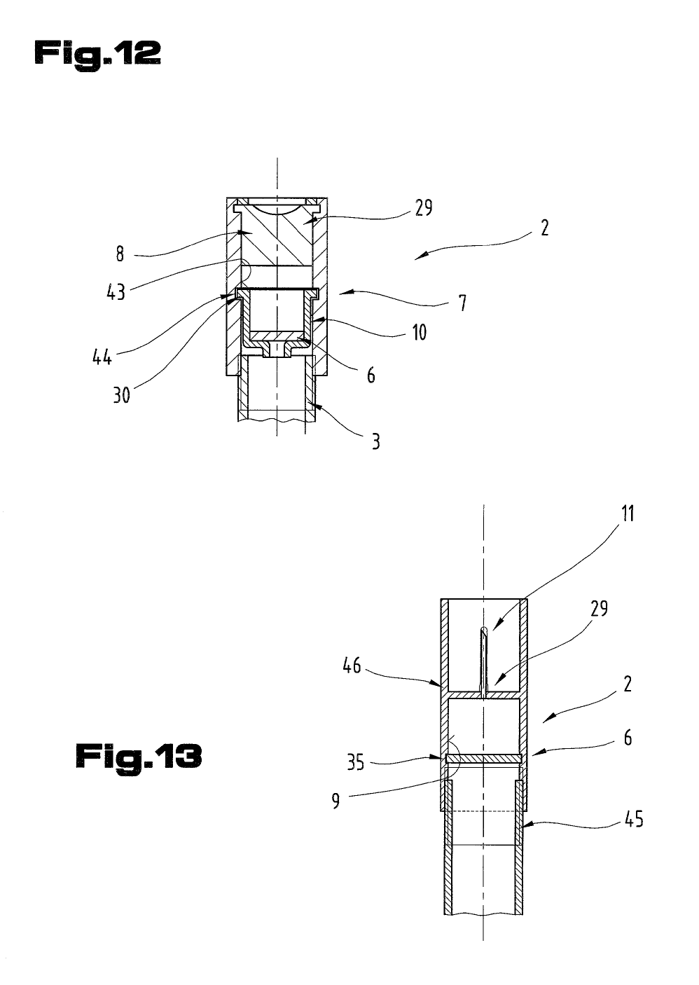

FIG. 12 illustrates an embodiment of the separating device 2, in particular the closure cap 7. In this case, an internal surface 43 thereof is provided with a groove 44, which is circumferential in particular, in which the separating element 6 is retained, again provided as a receptacle 28 with a lip 30 provided on its top opening similar to the embodiment illustrated in FIG. 2. Disposed above this opening of the receptacle 28 is the connecting element 29, provided as a septum 8, so as to produce a gas and/or liquid impermeable closure of the separating device.

The advantage of this is that when the closure cap 7 is removed from the separating device 2, i.e. the vessel 3, the separating element 6 is automatically removed from this vessel 3 at the same time, which means that the separating element 6 together with the closure cap 7 can be placed on another vessel, particularly if vessels 3 of the same type are used, in which additional processing or preparation of the component isolated from the sample of biological origin can be performed.

With this embodiment, it is also possible to dispense with the septum and use other connecting elements instead, for example a closure element of the type described with reference to FIG. 10.

Finally, FIG. 13 illustrates another embodiment of the separating device 2, which is of a two-part design. These two parts may be joined to one another by means of a thread 45, for example, although it would also be conceivable to use snap-fit connections. A connecting element 29, e.g. corresponding to the design illustrated in FIG. 11, is provided in a first top part 46 of the separating device 2 and the separating element 6, again of a plate-design, is disposed between it and the thread 45 in a groove 35 in the vessel interior wall 9.

This makes isolation easier once the component has been separated from the drained filtrate.

Particularly if using evacuated vessels 5 (see FIG. 1) or if using an evacuated separating device 2, the sequence in which the parts of the kit 1 proposed by the invention are fitted to one another may be important for reasons which are easy to understand. In order to get round any such problems, the connecting element 29, in particular the cannula 11, may be slidably retained, for example in the connecting device 4, so that the septum 12 of the separating device 2 is not pierced until after the septum 8 (see FIG. 1) has penetrated the other vessel 5, in other words the blood-sampling tube.

These two septums 8, 12, may also be made from different materials, in which case the hardness of septum 12 of the separating device 2, i.e. the resistance needed by this septum 12 to oppose penetration, is greater than the hardness of the septum 8 of the other vessel 5.

With these options, penetration will automatically occur in the correct sequence.

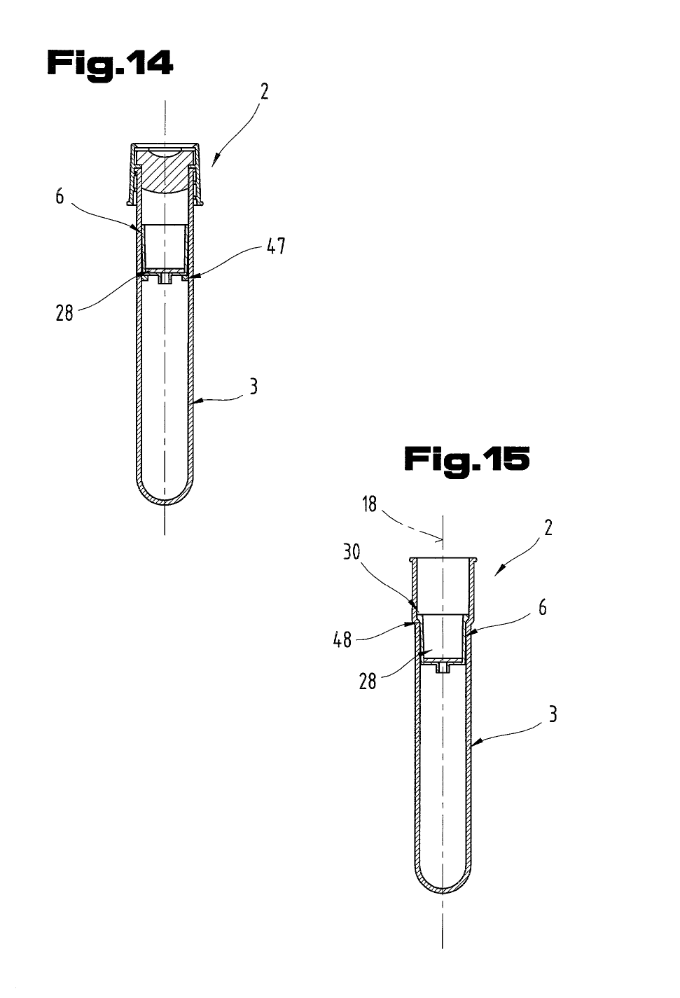

FIGS. 14 to 16 illustrate different embodiments of the separating device 2 with a separating element 6 inserted therein, provided in the form of the receptacle 28. As mentioned above, this receptacle 28 has two opposing openings, the lowermost of the two openings having a smaller diameter and serving as an outflow for the liquid phase or filtrate not held back by the separating element 6. As result of this smaller diameter, this filtrate is able to drain uniformly into the interior of the vessel 3 lying underneath.

The separating element 6 in the embodiments of FIGS. 14 to 16 is designed so that it can be removed from the vessel 3, for example so that it can be transferred to another vessel for additional pre-treatment of the species to be analysed. To this end, the separating element 6, in other words the receptacle 28, may have a maximum diameter, as mentioned above, more or less corresponding to an internal diameter of the receptacle 3 to produce a friction fit between the separating element 6 and the vessel 3.

Alternatively, as illustrated in FIG. 14, a retaining lip 47 may be provided, preferably running around at least part of the internal wall of the vessel 3, in particular made of the same material as and integral with the vessel 3, on which the separating element 6 can be retained. Consequently, the separating element 6, in other words the receptacle 28, may be of smaller dimensions than the internal diameter of the vessel 3, making it easier to remove from the vessel 3. The height of this retaining lip 47 is specifically selected so that the separating element 6, in particular the silicate membrane arranged therein, cannot be pierced by the cannula 11, not illustrated in FIG. 14, of the connecting device 4, also not illustrated.

FIGS. 15 and 16 illustrate embodiments designed to retain the separating element 6, in which the vessel 3 is of a wider cross section in the direction parallel with the longitudinal central axis 18, producing an offset vessel 3. This widening in the cross section of the upper region of the vessel 3 forms an annular bearing surface 48 on which the separating element 6, i.e. the receptacle 28, can be retained. As illustrated in FIGS. 15 and 16, the disposition of the bearing surface 48 can be varied in terms of its height relative to the overall height of the vessel 3 so that depending on whether the lip 30 of the separating element is retained on this bearing surface 48 or not (FIG. 15) or if it is not desirable to provide the lip 30 on the separating element 6, a bottom end face 49 of the separating element 6 arranged in the region of the smaller of the two openings of the separating element 6 can be retained.

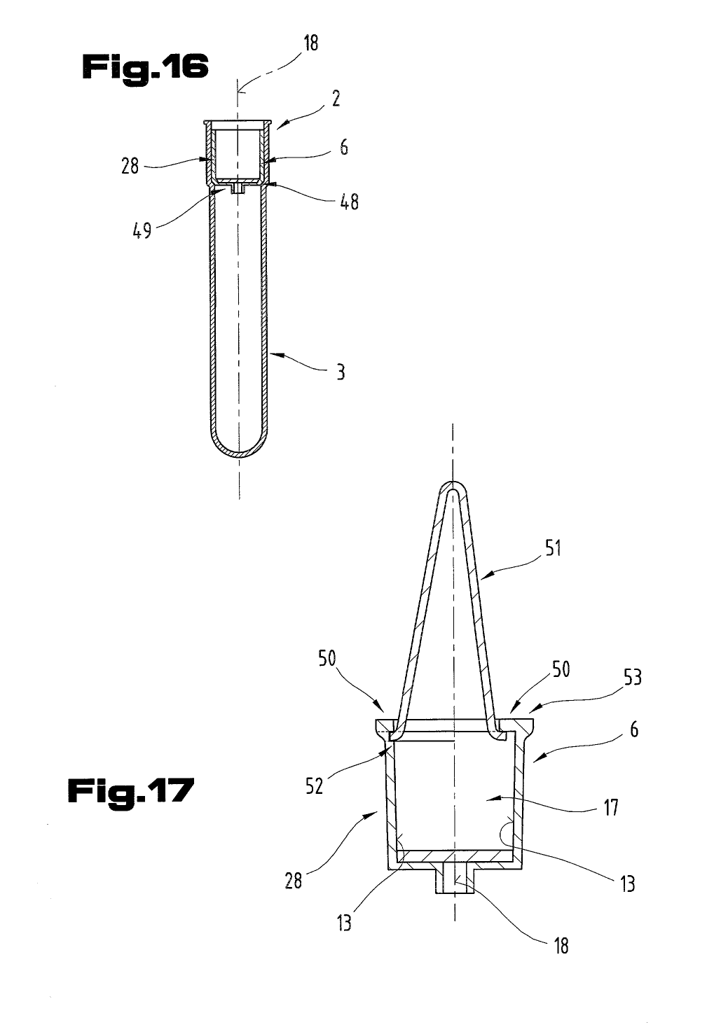

FIG. 17, finally, depicts different but not restrictive embodiments of the separating element 6, which again is provided in the form of the receptacle 28, with an extraction device 50 to enable the separating element 6 to be removed from the vessel 3 of the separating device 2 (not illustrated) using an extraction tool 51, for example appropriately designed tweezers, without having to touch the separating element 6 with the fingers, a factor which is particularly important when separating nucleic acids given that direct contact with the separating element 6 may run the risk of contaminating the nucleic acids separated on it from the biological sample.

In order to locate the extraction tool 51 in the extraction devices 50, the latter may be provided in the form of an annular groove 52 in the interior wall of the receptacle 28, as shown in the left-hand part of FIG. 17. Clearly, this groove-shaped recess need not necessarily be provided around the entire circumference of the interior wall but may be disposed on only part of the interior wall.

Alternatively, this groove could also be made longer so that an orifice is provided through the wall of the receptacle 28, as shown by broken lines in the left-hand part of FIG. 17.

The right-hand part of FIG.,. 17 depicts an option in which an annular, circumferential projection 53 is provided on the interior wall in the region of the inlet opening for the sample, in other words the larger of the two openings of the receptacle, 28 in particular integrally with the wall of the receptacle 28. This projection 53 points in the direction towards the longitudinal central axis 18, so that when the extraction tool 51 is introduced into the interior of the receptacle 28, it engages with the underside of the projection 53, i.e. the face having the smaller of the two openings, so that the separating element 6 can be removed from the vessel 3, not illustrated.

As mentioned above, the extraction tool 51 may be provided in the form of tweezers with end-projections—as illustrated in FIG. 17—at least approximately perpendicular to the main direction of the tweezers enabling them to locate in the direction of extraction.

Clearly, the methods and devices for easy removal of the separating element 6 from the container 3 are not limited to those illustrated here and other embodiments are included within the scope of the invention. For example, the separating element 6 may be at least partially made from a metal or metal may be provided on it so that the separating element 6 can be removed from the vessel 3 using a magnet. Similarly, it would be conceivable to provide eyelets in the separating element 6 in the region of the larger of the two openings, i.e. the inlet opening of the receptacle 28, which may be integral with the receptacle 28, in which case the extraction tool 51 will locate in these eyelets. Likewise, it would be conceivable to provide the separating device 6 with tongues, which could optionally be guided between the closure cap 21 and the vessel 3, in which case the tongues of this embodiment would engage with fingers once the closure cap 21 was removed and the separating element 6 could then be pulled out of the vessel 3.

Finally, it should also be pointed out that different combinations of the individual elements of the analysis kit, in particular the different embodiments, are possible, it being possible for these elements to have specific details taken from designs described in relation to different embodiments.

For the sake of good order, it should finally be pointed out that in order to provide a clearer understanding of the structure of the kit 1 and the separating device 2, they and their constituent parts have been illustrated out of scale to a certain extent and/or on an enlarged and/or reduced scale.

The tasks underlying the independent inventive solutions can be found in the description.

Above all, the subject matter relating to the individual embodiments illustrated in FIGS. 1; 2; 3; 4; 5; 6; 7, 8; 9; 10; 11; 12; 13; 14; 15; 16; 17 can be construed as independent solutions proposed by the invention. The tasks and solutions can be found in the detailed descriptions relating to these drawings.

Reference Numbers

| | |
|---|---|
| 1 | Kit |
| 2 | Separating device |
| 3 | Vessel |
| 4 | Connecting device |
| 5 | Vessel |
| 6 | Separating element |
| 7 | Closure cap |
| 8 | Septum |
| 9 | Vessel interior wall |
| 10 | Vessel |
| 11 | Cannula |
| 12 | Septum |
| 13 | Vessel interior wall |
| 14 | Safety feature |
| 15 | Vessel height |
| 16 | Height |
| 17 | Vessel interior |
| 18 | Longitudinal central axis |
| 19 | Vessel lip |
| 20 | Separating device interior |
| 21 | Closure cap |
| 22 | Closure cap internal wall |
| 23 | Vessel bottom part |
| 24 | Vessel bottom part |
| 25 | Length |
| 26 | Spacing |
| 27 | Closure cap end face |
| 28 | Receptacle |
| 29 | Connecting element |
| 30 | Lip |
| 31 | External diameter |
| 32 | External diameter |
| 33 | Lip |
| 34 | Lip |
| 35 | Groove |
| 36 | External casing |
| 37 | Groove |
| 38 | Projection |
| 39 | Base plate |
| 40 | Thread |
| 41 | Closure element |
| 42 | Dividing wall |
| 43 | Surface |
| 44 | Groove |
| 45 | Thread |
| 46 | Part |
| 47 | Retaining lip |
| 48 | Bearing surface |
| 49 | End face |
| 50 | Extraction device |
| 51 | Extraction tool |
| 52 | Annular groove |
| 53 | Projection |

1. Separating device for isolating at least one component from a sample of biological origin, in particular nucleic acids from whole blood, comprising a liquid-permeable separating element, having pores in particular, arranged in a vessel, characterised in that the vessel has an at least virtually gas-impermeable connecting element at one of its end regions for connecting the vessel to another vessel or has a connecting device for another vessel, e.g. a blood-sampling tube.

2. Device according to claim 1, characterised in that the vessel has a connecting element at both end regions.

3. Device according to claim 1 or 2, characterised in that the connecting element is a piercable, self-closing septum.

4. Device according to claim 3, characterised in that the septum is retained in a screw cap.

5. Device according to one of the preceding claims, characterised in that the connecting element has a closure element, .g. a tap.

6. Device according to one of the preceding claims, characterised in that the connecting element has a device for penetrating a septum, e.g. a cannula.

7. Device according to one of the preceding claims, characterised in that the connecting element has a fixing element, e.g. a snap-fit closure, for the other vessel or the connecting device.

8. Device according to one of the preceding claims, characterised in that the separating element is selected from a group consisting of filters, silicate membranes, ion-ex-changer membranes and columns or separating columns.

9. Device according to one of the preceding claims, characterised in that the separating element is arranged in a receptacle that can be placed in the vessel.

10. Device according to one of the preceding claims, characterised in that the receptacle has at least two openings, a lip being arranged in the region of one opening which extends at least partially around the circumference of the receptacle.

11. Device according to claim 10, characterised in that an external diameter of the lip corresponds at least approximately to a maximum external diameter of the vessel.

12. Device according to one of the preceding claims, characterised in that the separating element is removably arranged in the vessel.

13. Device according to one of the preceding claims, characterised in that an annular groove is provided on an internal face of the vessel for fixing the separating element or the receptacle, e.g. the lip.

14. Device according to one of the preceding claims, characterised in that the vessel has a lip, in particular annular, on its internal face for retaining the separating element or the receptacle.

15. Device according to one of the preceding claims, characterised in that the vessel has a cross section widening in the direction of a longitudinal central axis and this cross section widening forms an annular bearing surface for the separating element.

16. Device according to one of the preceding claims, characterised in that the receptacle is secured to the screw cap, in particular removably.

17. Device according to one of the preceding claims, characterised in that a stationary phase for at least one additional component is disposed in the receptacle.

18. Device according to one of the preceding claims, characterised in that the vessel is evacuated and/or can be evacuated.

19. Device according to one of the preceding claims, characterised in that the vacuum is such that a predeterminable quantity of the sample can be sucked into the vessel.

20. Device according to one of the preceding claims, characterised in that the vessel is provided in the form of a blood-sampling tube.

21. Device according to one of the preceding claims, characterised in that an extraction device is provided on the receptacle which is able to engage with an extraction tool, e.g. tweezers.

22. Device according to one of the preceding claims, characterised in that the extraction device is provided in the form of an annular groove in the interior wall of the receptacle or a projection from the interior wall of the receptacle pointing in the direction of the longitudinal central axis or an orifice or a metal element.

23. Kit for isolating at least one component from a sample of biological origin, in particular nucleic acids from whole blood, comprising a separating device according to one of the preceding claims and a connecting device for providing an at least more or less gas-impermeable connection between the separating device and another vessel as well as the other vessel.

24. Kit according to claim 23, characterised in that the connecting device has at least one device for penetrating a septum to establish a flow connection between the separating device and the other vessel.

25. Kit according to claim 23 or 24, characterised in that the penetrating device is a cannula, which is double-ended in particular.

26. Kit according to one of claims 23 to 25, characterised in that the connecting device is provided in the form of a vessel.

27. Kit according to claim 26, characterised in that the cannula is retained in an end region of the vessel.

28. Kit according to one of claims 23 to 27, characterised in that at least one cannula end has a safety feature.

29. Kit according to one of claims 23 to 28, characterised in that the connecting device has a closure element, e.g. a tap, for interrupting the flow connection.

30. Kit according to one of claims 23 to 29, characterised in that a fixing element, e.g. a snap-fit closure, for the vessel or vessels is provided in at least one end region of the connecting device.

31. Kit according to one of claims 23 to 30, characterised in that the other vessel is a blood-sampling tube.

32. Kit according to one of claims 23 to 31, characterised in that a reagent or a reagent mixture is placed in the other vessel to stabilise and/or lyse whole blood.

33. Kit according to claim 32, characterised in that the reagent or reagent mixture is a guanidinium salt.

34. Method of isolating at least one component from a sample of biological origin, in particular nucleic acids from whole blood, whereby the sample is collected in a first, in particular evacuated, vessel where the sample or component is stabilised, characterised in that at least a part of the stabilised sample is transferred to a second, in particular evacuated, vessel by establishing a flow connection between the vessels, the component being collected on a separating element.

35. Method according to claim 34, characterised in that the second vessel is a separating device according to one of claims 1 to 22.

36. Method according to claim 34 or 35, characterised in that when the component has been separated from the sample, the separating element is removed from the vessel.

37. Method according to claim 36, characterised in that the separating element is transferred to another vessel, where the component is washed and/or eluted from the separating device.

38. Method according to claim 34 or 35, characterised in that the sample element separated from the component is removed from the second vessel and the component in the second vessel is washed with a buffer solution.

39. Method according to one of claims 34 to 38, characterised in that the second vessel is evacuated prior to a washing step.

40. Method according to one of claims 34 to 38, characterised in that the buffer solution is transferred from the second vessel into another vessel in flow connection with this vessel by above-atmospheric pressure.

41. Use of the separating device according to one of claims 1 to 22 for separating at least a nucleic acid from whole blood.

42. Use of the kit according to one of claims 23 to 33 for separating at least a nucleic acid from whole blood.
